(19) United States
(12) Patent Application Publication
(10) Pub. No.: US 2023/0011758 A1
(43) Pub. Date: Jan. 12, 2023

(54) WORK MACHINE AND CONTROL METHOD FOR WORK MACHINE

(71) Applicant: KOMATSU LTD., Tokyo (JP)

(72) Inventor: Kazumichi OKAJIMA, Tokyo (JP)

(21) Appl. No.: 17/782,399

(22) PCT Filed: Mar. 2, 2021
(86) PCT No.: PCT/JP2021/007848

§ 371 Date: Jun. 3, 2022

(30) Foreign Application Priority Data
Mar. 16, 2020 (JP) 2020-045321

(51) Int. Cl. E02F 9/26; E02F 9/24; B60R 1/25; B60Q 9/00

(52) U.S. Cl. CPC E02F 9/261; B60Q 9/008; B60R 1/25; E02F 9/24; B60R 2300/20; B60R 2300/8093; E02F 3/32

(57) ABSTRACT

The hydraulic excavator includes a vehicle body, a work implement , a display section, a detection section , and a display control section. The vehicle body includes a driver’s seat . The work implement is attached to the vehicle body and operates with respect to the vehicle body. The display section is provided on the work implement. The detection section detects an object in a region on a side opposite to the driver’s seat with respect to the work implement around the vehicle body. The display control section displays the information detected by the detection section on the display section.

### CROSS-REFERENCE TO RELATED APPLICATIONS

This application is a U.S. National stage application of International Application No. PCT/JP2021/007848, filed on Mar. 2, 2021. This U.S. National Stage Application claims priority under 35 U.S.C. §119(a) to Japanese Patent Application No. 2020-045321, filed in Japan on Mar. 16, 2020, the entire contents of which are hereby incorporated herein by reference.

### TECHNICAL FIELD

The present invention relates to a work machine and a control method for a work machine.

### BACKGROUND INFORMATION

In the hydraulic excavator, a work implement is generally provided next to the cab. Therefore, in the operator’s field of view, there is a blind spot that is blocked by the boom of the work implement.

In order to resolve such a blind spot, it has been proposed to display a landscape outside the vehicle which is a blind spot (see, for example, Japanese Patent Application H10-299032).

In the hydraulic excavator shown in Japanese Patent Application H10-299032, it is disclosed that a camera for taking a blind spot image is provided and the blind spot image is displayed on a non-transmissive LCD screen attached to a window of a cab blocked by a work implement.

SUMMARY However, in the hydraulic excavator of Japanese Patent Application H10-299032, since the non-transmissive LCD screen is attached to the window, the visibility is deteriorated, and it becomes difficult for the operator to see the outside of the vehicle through the window.

It is an object of the present disclosure to provide a work machine and a control method for a work machine capable of allowing an operator to recognize an object existing in a blind spot without impairing visibility from a driver’s seat.

A work machine according to a first aspect includes a vehicle body, a work implement, a display section, a detection section and a display control section. The vehicle body includes a driver’s seat. The work implement is attached to the vehicle body and operates with respect to the vehicle body. The display section on provided in the work implement. The detection section detects an object in a region on a side opposite to the driver’s seat with reference to the work implement around the vehicle body. The display control section displays information detected by the detection section on the display section.

A work machine according to a second aspect includes a vehicle body, a work implement, a display section, a detection section, and a display control section. The vehicle body includes a driver’s seat. The work implement is attached to the vehicle body and operates with respect to the vehicle body. The display section is provided on the work implement. The detection section detects an object in a region on a side opposite to the driver’s seat with reference to the work implement around the vehicle body. The display control section displays an information according to a detection result of the detection section on the display section.

A control method for a work machine according to a third aspect includes an imaging step, a boom angle detection step, a blocked area determination step, a blocked area extraction step, and a display step. The imaging step captures an image in a region on a side opposite to a driver’s seat with reference to a work implement around a vehicle body. The boom angle detection step detects an elevation angle of the boom. The blocked area determination step determines a blocked area in which an operator’s field of view is blocked by the boom based on a detected elevation angle of the boom. The blocked area extraction step extracts an image data of the blocked area from an image data captured by the imaging step. The display step displays an image based on an extracted image data on a side surface of the boom performed elevation.

According to the present disclosure, it is possible to provide a work machine and a control method for a work machine capable of allowing an operator to recognize an object existing in a blind spot without impairing visibility from a driver’s seat.

### BRIEF DESCRIPTION OF THE DRAWINGS

FIG. 1 is a perspective view showing a hydraulic excavator of Embodiment 1 according to the present disclosure.

FIG. 2 is a plan view showing the hydraulic excavator of FIG. 1.

FIG. 3 is a side view showing a cab of the hydraulic excavator of FIG. 1.

FIG. 4 is a plan view showing a detection region by a detection section of the hydraulic excavator of FIG. 1.

FIG. 5 is a view showing a field of view from a driver’s seat of the hydraulic excavator of FIG. 1.

FIG. 6 is a block diagram showing a control configuration of the hydraulic excavator of FIG. 1.

FIG. 7A is a view showing an example of an image data acquired from the detection section of the hydraulic excavator of FIG. 1.

FIG. 7B is a view showing an example of an image data changed an angle of view from the image data of FIG. 7A.

FIG. 7C is a view showing a blocked area in the image data of FIG. 7B.

FIG. 7D is a view showing an image data extracted the blocked area from the image data of FIG. 7C.

FIG. 7E is a view showing an image data in which a warning display is added to the image data of FIG. 7D.

FIG. 8 is a flow chart showing a control operation of the hydraulic excavator of FIG. 1.

FIG. 9 is a plan view of a hydraulic excavator of Embodiment 2 according to the present disclosure.

FIG. 10 is a block diagram showing a control configuration of the hydraulic excavator of FIG. 9.

FIG. 11 is a view showing a field of view from the driver’s seat of the hydraulic excavator of FIG. 9.

FIG. 12 is a flow chart showing a control operation of the hydraulic excavator of FIG. 9.

FIG. 13 is a view showing a predetermined area in a detection region of the hydraulic excavator of a modification of Embodiment 2 according to the present disclosure.

### DESCRIPTION OF EMBODIMENTS

A hydraulic excavator as an example of a work machine according to the present disclosure will be described below with reference to the drawings.

### Embodiment 1

Hereinafter, the hydraulic excavator of a first embodiment according to the present disclosure will be described.

### Configuration

### Overview of Hydraulic Excavator

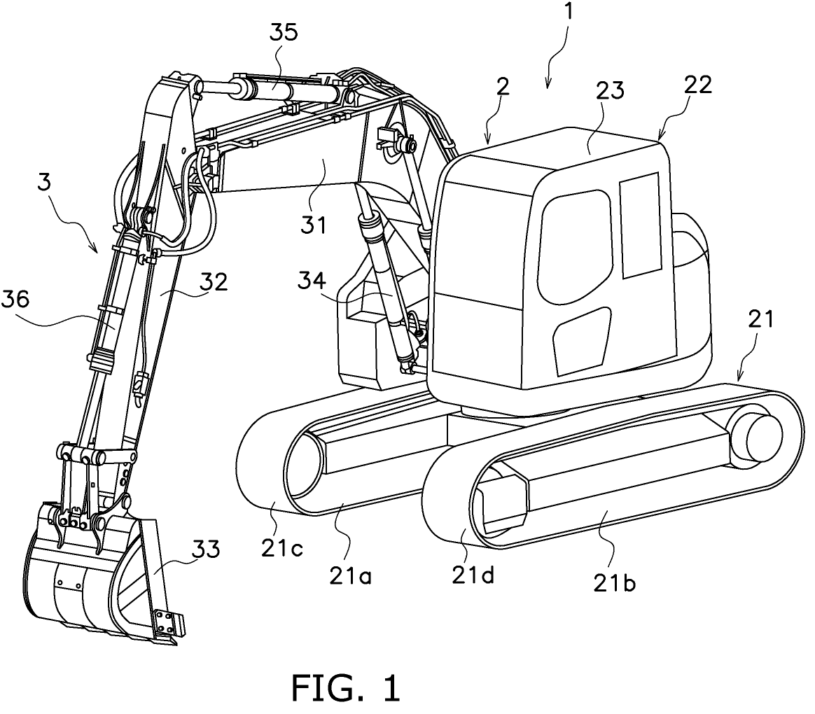

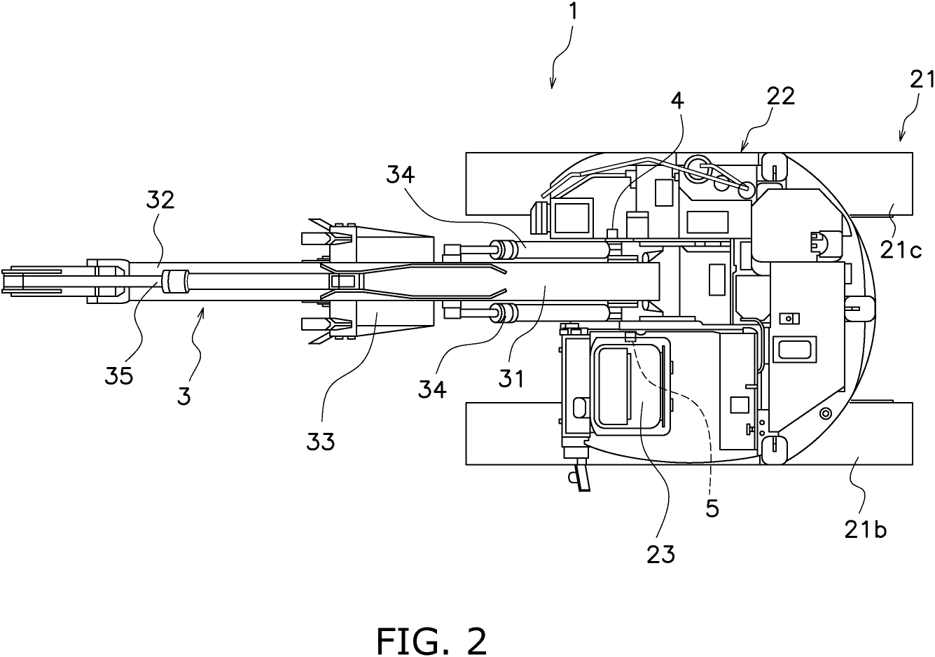

FIG. 1 is a schematic view showing a configuration of the hydraulic excavator 1 of the present embodiment. FIG. 2 is a top view of the hydraulic excavator 1.

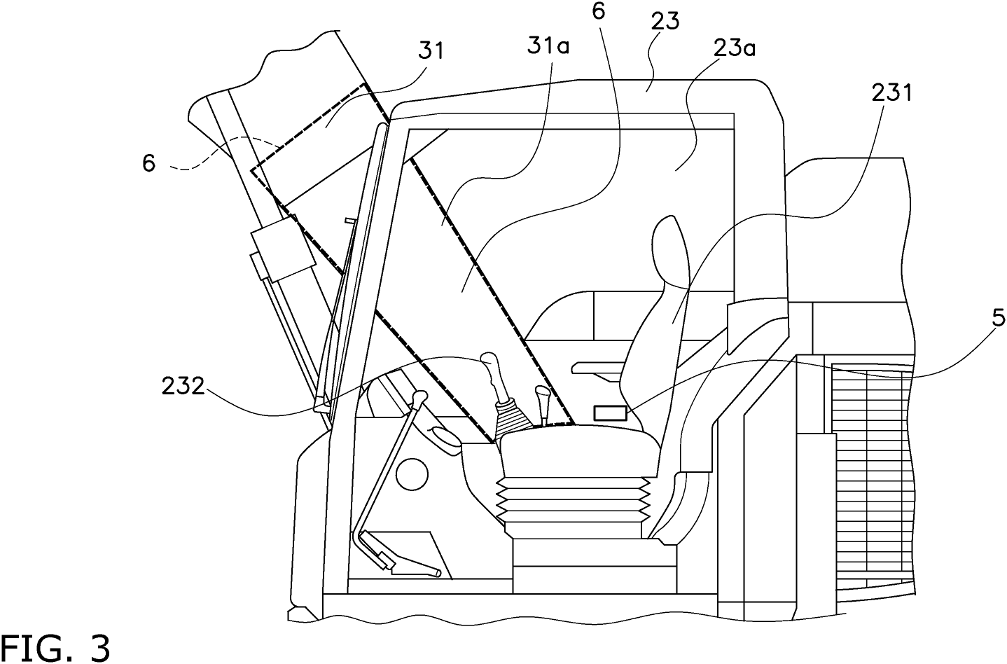

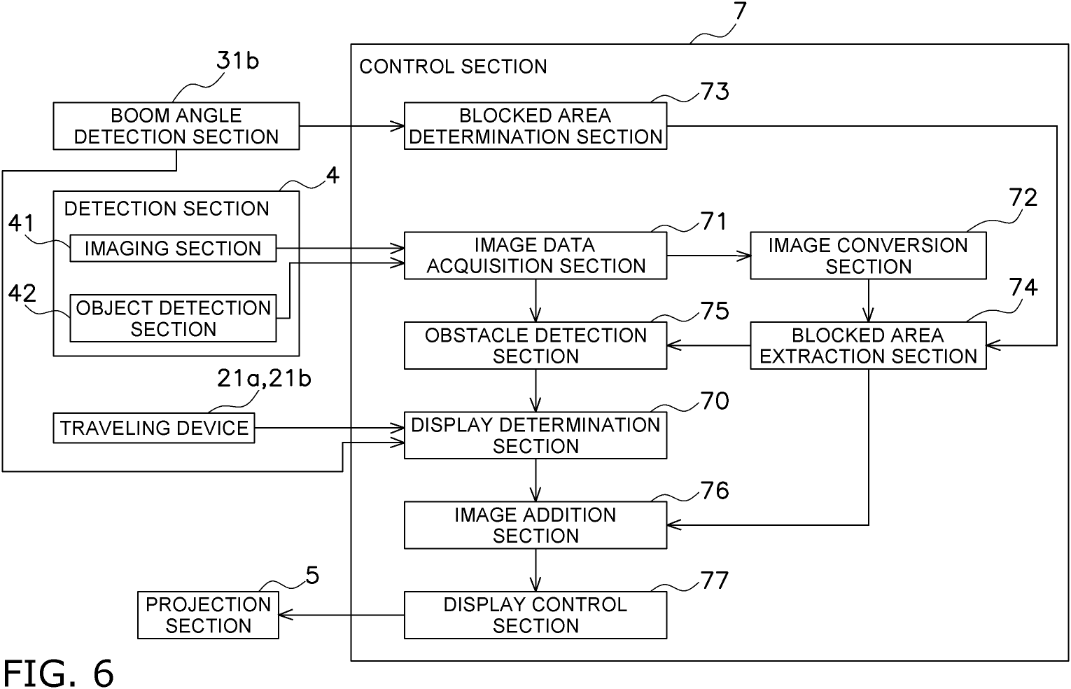

The hydraulic excavator 1 (an example of a work machine) includes a vehicle body 2, a work implement 3, a detection section 4 (FIG. 2), a projection section 5, a display section 6 (FIG. 3 described later), and a control section 7 (FIG. 6 described later). As shown in FIG. 1, the vehicle body 2 includes a traveling unit 21 and a revolving unit 22. The traveling unit 21 includes a pair of traveling devices 21a and 21b. Each of the traveling devices 21a and 21b includes the crawler belts 21c and 21d. The hydraulic excavator 1 travels by rotating a traveling motor with the driving force from an engine and driving the crawler belts 21c and 21d.

The revolving unit 22 is arranged on the traveling unit 21. The revolving unit 22 is provided so as to be revolvable with respect to the traveling unit 21 about an axis along a vertical direction by a revolving device (not shown).

A cab 23 as a driver’s seat on which the operator sits during driving is provided at a position on the left side of the front portion of the revolving unit 22. FIG. 3 is a side view of the cab 23. As shown in FIG. 3, a driver’s seat 231, a lever 232 for operating the work implement 3, various display devices, and the like are arranged inside the cab 23.

The revolving unit 22 accommodates an engine, a hydraulic pump, and the like (not shown) on the rear side. Unless otherwise specified in the present embodiment, the front, rear, left and right will be described with reference to the driver’s seat in the cab 23. The direction in which the driver’s seat faces the front is the front direction, and the direction facing the front direction is the back direction. The right side and the left side in the lateral direction when the driver’s seat faces the front are the right direction and the left direction, respectively.

As shown in FIG. 1, the work implement 3 includes a boom 31, an arm 32, and an excavation bucket 33 (an example of an attachment), and is attached to the front center position of the revolving unit 22. The work implement 3 is disposed on the right side of the cab 23. A base end portion of the boom 31 is rotatably connected to the revolving unit 22. Further, a tip end portion of the boom 31 is rotatably connected to a base end portion of the arm 32. A tip end portion of the arm 32 is rotatably connected to the excavation bucket 33. The excavation bucket 33 is attached to the arm 32 so that its opening can face the direction (backward) to the vehicle body 2. A hydraulic excavator in which the excavation bucket 33 is attached in such an orientation is called a backhoe.

Hydraulic cylinders 34 to 36 (boom cylinder 34, arm cylinder 35 and bucket cylinder 36) are disposed so as to correspond to the boom 31, the arm 32 and the excavation bucket 33, respectively. The work implement 3 is driven by driving these hydraulic cylinders 34 to 36. As a result, work, such as excavation, is performed.

As shown in FIG. 3, the base end portion of the boom 31 is disposed laterally with respect to the driver’s seat 231, and the boom 31 rotates upward and downward in front of the revolving unit 22 by driving the boom cylinder 34. Therefore, when the boom 31 rotates upward, the field of view from the operator seated in the driver’s seat 231 is blocked by the boom 31, and a blind spot is generated.

As information for specifying an area where the field of view is blocked, a position of the driver’s seat 231 and coordinates for specifying the predetermined height (the position of the operator’s eye line) are set in advance. The eye line of the operator is defined by a known method including inputting a set value, such as inputting in advance on a monitor or the like. The operator’s eye line can be set for each operator, and can be read out, for example, by inputting the operator’s ID.

By specifying the position of the driver’s seat 231 and the position of the operator’s eye line, the distance from the operator to the boom 31 can be specified, so that the area where the view is blocked by the boom 31 can be specified.

### Detection Section 4

The detection section 4 detects an object in a region where the field of view from the driver’s seat 231 may be blocked by the boom 31 around the vehicle body 2.

As shown in FIG. 2, the detection section 4 is provided on the revolving unit 22. The detection section 4 is provided on the opposite side of the cab 23 with the work implement 3 interposed therebetween. The detection section 4 is disposed on the right side of the work implement 3 (an example of a first direction side).

As shown in FIG. 6, which will be described later, the detection section 4 includes an imaging section 41 and an object detection section 42. A camera or the like can be used as the imaging section 41. Further, as the imaging section 41, for example, a CCD image sensor or the like can be used. The imaging section 41 takes an image of a region R1 on the side opposite to the cab 23 of the work implement 3 around the vehicle body 2.

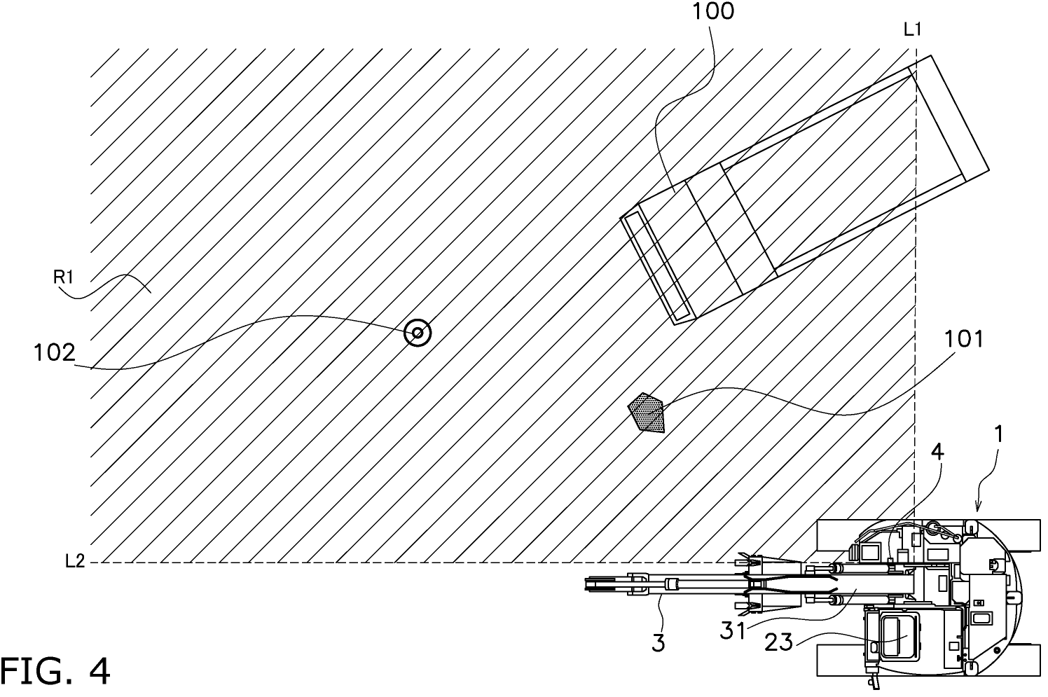

FIG. 4 is a view showing a region R1 detected by the detection section 4 around the vehicle body 2. As shown in FIG. 4, the region R1 is in the right front direction of the hydraulic excavator 1. For example, the region R1 may be between a line L1 extending to the right from the base end of the boom 31 of the work implement 3 and an extension line L2 extending a right side surface of the boom 31 forward. The region R1 is a region around the vehicle body 2 where the operator’s field of view may be blocked by the boom 31.

The image taken by the imaging section 41 is transmitted to the control section 7.

The object detection section 42 detects an object. As the object detection section 42, a laser, a sound wave, a stereo camera, or the like may be used, but the object detection section 42 is not limited to this, and an object may be detected by analyzing the image captured by the imaging section 41 in post-processing. The object detection section 42 can measure the distance to the object existing in the region R1.

In the plan view of FIG. 4, a dump truck 100, a road cone 102, and a rock 101 are shown in the region R1. The imaging section 41 captures an image including the dump truck 100, the road cone 102, and the rock 101.

Further, the object detection section 42 can measure the distances from the hydraulic excavator 1 to the dump truck 100 and the rock 101. In the plan view of FIG. 4, it can be seen that the rock 101 is disposed at a position close to the vehicle body 2.

Further, means for arbitrarily adjusting the detection angles of the imaging section 41 and the object detection section 42 are provided.

The imaging section 41 and the object detection section 42 may be provided one by one, but a plurality of imaging section 41 and a plurality of object detection section 42 may be provided for accurate detection.

### Projection Section 5, Display Section 6

The projection section 5 projects an image on a surface of the work implement 3 based on information detected by the detection section 4.

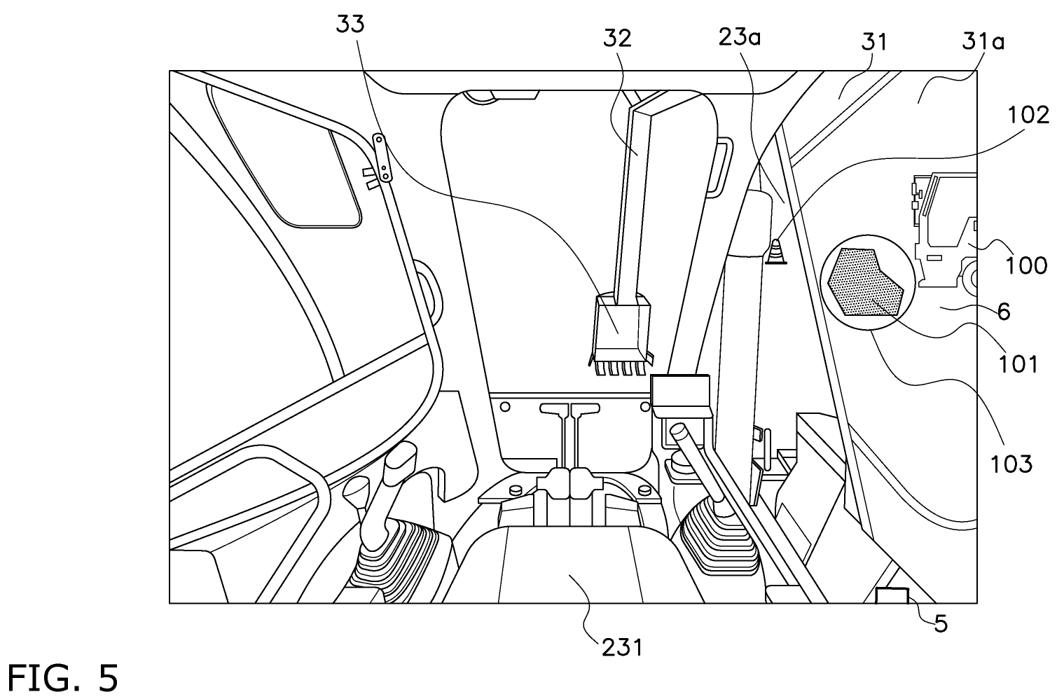

FIG. 5 is a view showing a field of view from an operator seated in the driver’s seat 231.

The installation position of the projection section 5 is not particularly limited, but in the present embodiment, the projection section 5 is disposed inside the cab 23 as shown in FIG. 5. Further, the projection section 5 is disposed in the vicinity of a right side surface of the cab 23.

The projection section 5 projects an image onto the display section 6 on a left side surface 31a of the boom 31 via the window 23a of the cab 23, based on the instruction signal from the control section 7. The display section 6 shows a part projected by the projection section 5 on the left side surface 31a of the boom 31. As the projection section 5, for example, a short focus projector can be used, and an image is projected on the left side surface 31a of the boom 31 by using projection mapping. Although the display section 6 is shown by a dotted line in FIG. 3, since the area where the operator’s field of view is blocked is variable depending on the angle of the boom 31, the area of the display section 6 also changes depending on the angle of the boom 31.

For example, by projection by the projection section 5, the dump truck 100 and the rock 101 shown in FIG. 4 can be displayed on the display section 6 as shown in FIG. 5. Since the road cone 102 is not blocked by the boom 31, the operator can directly see it through the window 23a.

### Control Section 7

FIG. 6 is a block diagram showing a control configuration of the hydraulic excavator 1 of the present embodiment.

The control section 7 includes a processor and a storage device. The processor is, for example, a CPU (Central Processing Unit). Alternatively, the processor may be a processor different from the CPU. The processor executes a process for controlling the hydraulic excavator 1 according to a program. The storage device includes a non-volatile memory, such as ROM (Read Only Memory), and a volatile memory, such as RAM (Random Access Memory). The storage device may include an auxiliary storage device, such as a hard disk or an SSD (Solid State Drive). A storage device is an example of a non-transitory recording medium that can be read by a computer. The storage device stores programs and data for controlling the hydraulic excavator.

The control section 7 includes following functions by executing a program while using the data stored in the storage device.

The control section 7 includes a display determination section 70, an image data acquisition section 71, an image conversion section 72, a blocked area determination section 73, a blocked area extraction section 74, an obstacle detection section 75, an image addition section 76 and a display control section 77.

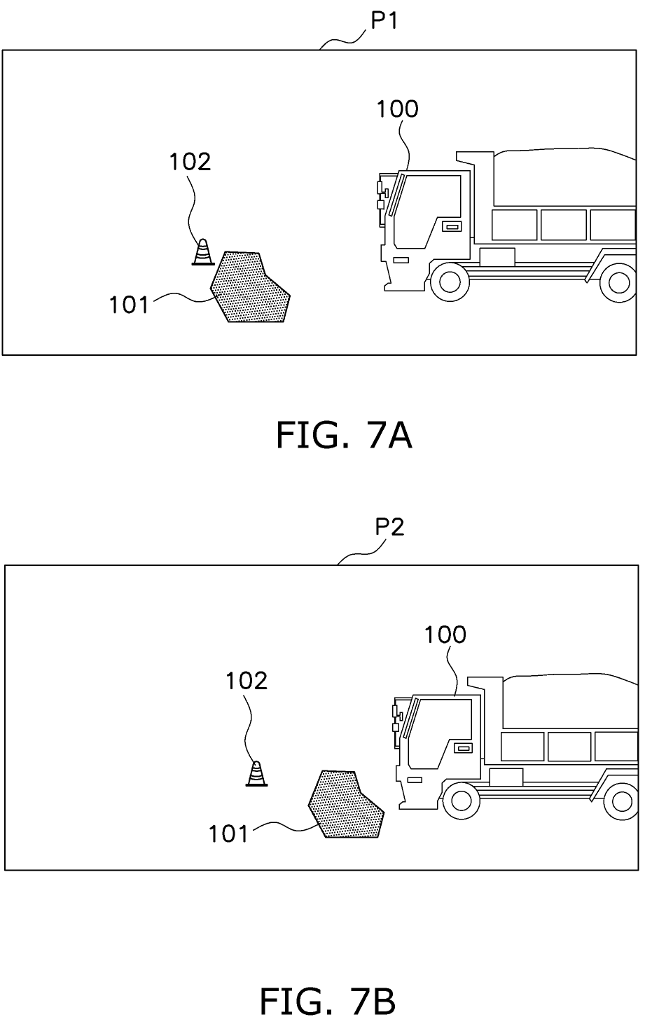

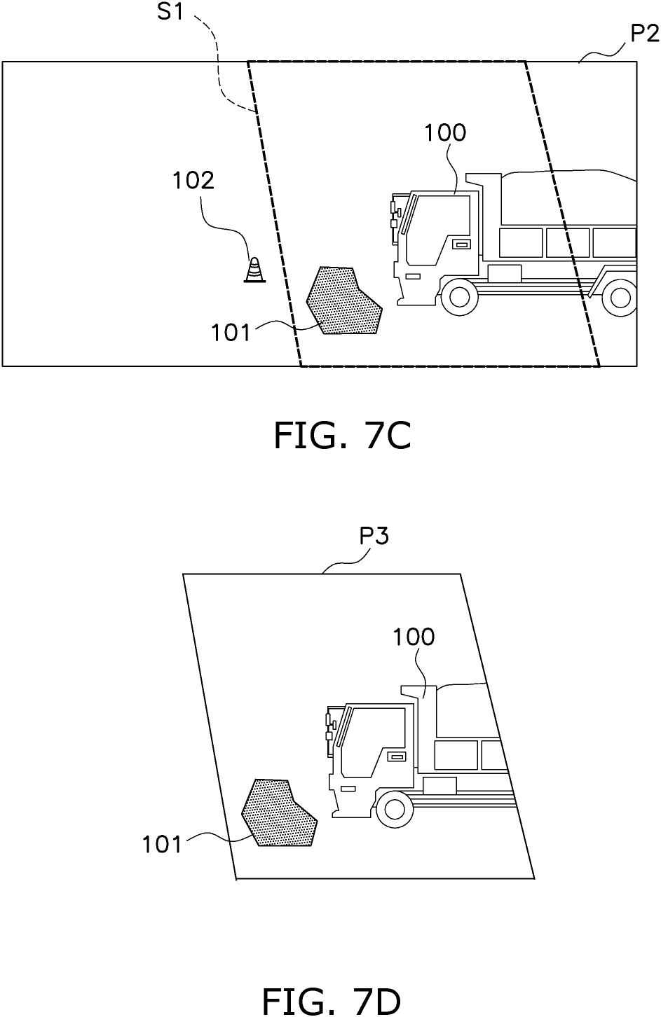

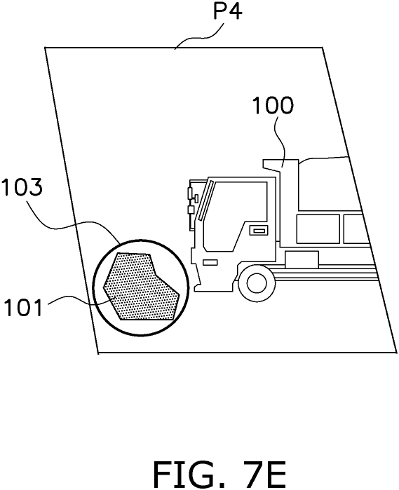

The image data acquisition section 71 acquires the image data of the region R1 from the imaging section 41, and acquires the object information in the region R1 from the object detection section 42. FIG. 7A is a view showing an example of acquired image data. FIG. 7A shows the image data P1 taken by the imaging section 41 of the detection section 4. The image data P1 shows a dump truck 100, a rock 101, and a road cone 102.

The image conversion section 72 converts the angle of view of the extracted image. The image captured by the imaging section 41 has a different angle of view from the image of the viewpoint from the operator seated in the driver’s seat 231. Therefore, the image conversion section 72 converts the angle of view of the image captured by the imaging section 41 so as to match the viewpoint from the operator seated in the driver’s seat 231. FIG. 7B is a view showing image data P2 in which the angle of view of image data P1 is converted. In FIG. 7B, the positional relationship and size of the dump truck 100, the rock 101 and the road cone 102 are different from those in FIG. 7A.

The blocked area determination section 73 determines an area blocked by the boom 31 based on the boom angle detection section 31b. Depending on the angle of the boom 31, the area where the operator’s field of view seated in the driver’s seat 231 is blocked changes. Therefore, a block area is obtained and stored in advance for each angle of the boom 31, and by detecting the angle of the boom 31, the area where the operator’s field of view is blocked by the boom 31 can be determined. In FIG. 7C, the area S1 blocked by the boom 31 on the image data P1 is shown by a dotted line.

The blocked area extraction section 74 extracts the image of the blocked area S1 determined by the blocked area determination section 73 from the image data P2 whose angle of view has been changed. FIG. 7D is a view showing an image data P3 of the extracted blocked area S1. In this way, the blocked area S1 is extracted as the image data P3 in the blocked area from the image data P2. In the extracted image data P3, the road cone 102 is excluded, but the road cone 102 can be directly visually recognized by the operator as shown in FIG. 4.

The obstacle detection section 75 detects an obstacle based on the data from the detection section 4. The obstacle detection section 75 detects an obstacle in the image data P3 of the extracted blocked area. The obstacle detection section 75 detects the distance of the object to the vehicle body 2 in the image data P3 based on the data of the object detection section 42, and when the distance is within a predetermined range, the obstacle detection section 75 detects the object as an obstacle. The obstacle detection section 75 may receive the object information in the region R1 from the object detection section 42 via the image data acquisition section 71, or may receive the object information directly from the object detection section 42.

In the example shown in FIG. 7D, the image data P3 includes the dump truck 100 and the rock 101 as objects, but the rock 101 is detected as an obstacle because the distance from the vehicle body 2 is within a predetermined range. It should be noted that not only an object within a predetermined range from the vehicle body 2 is detected as an obstacle, but also, for example, the object may be determined as an obstacle by the object approaching the hydraulic excavator 201 even when the object is located at a position farther than the predetermined range. In addition, a means for setting the characteristics of the obstacle may be provided.

The display determination section 70 determines whether or not to display an image and/or a warning based on the detection of the operation. The display determination section 70 determines that, for example, in the case of forward travel or working state, a warning display of an obstacle in the right front direction is performed. The forward travel can be determined from the drive of the traveling devices 21a and 21b. Further, the working state can be determined from the movement of work implement 3 (for example, the movement of the boom 14), the operation of work implement 3 (lever operation), and the like. Further, the display determination section 70 determines that the display is not performed when, for example, the vehicle body 2 is stopped and the work implement 3 is not operated.

When it is determined to display, the image addition section 76 adds the information of the detected obstacle to the extracted image data P3. As the information of the obstacle, for example, warning information can be mentioned. For example, when the rock 101 is detected as an obstacle based on the distance to the vehicle body 2, as shown in FIG. 7E, a circle 103 (red circle) surrounding the rock 101 is added to the image data P3 and an image data P4 is created. Such a circle 103 is an example of a warning. A warning is not limited the circle 103 surrounding the rock 101, and the rock 101 itself may be red. In short, a warning may be a warning display that can notify the operator of the existence of the rock 101.

The display control section 77 controls the projection section 5 so as to project the image created by the image addition section 76 onto the left side surface 31a of the boom 31. FIG. 4 shows a state in which the image data P4 shown in FIG. 7E is projected onto the left side surface 31a of the boom 31.

### Operation

Next, the operation of the hydraulic excavator 1 of the embodiment according to the invention will be described, and an example of the control method for the work machine will be described at the same time.

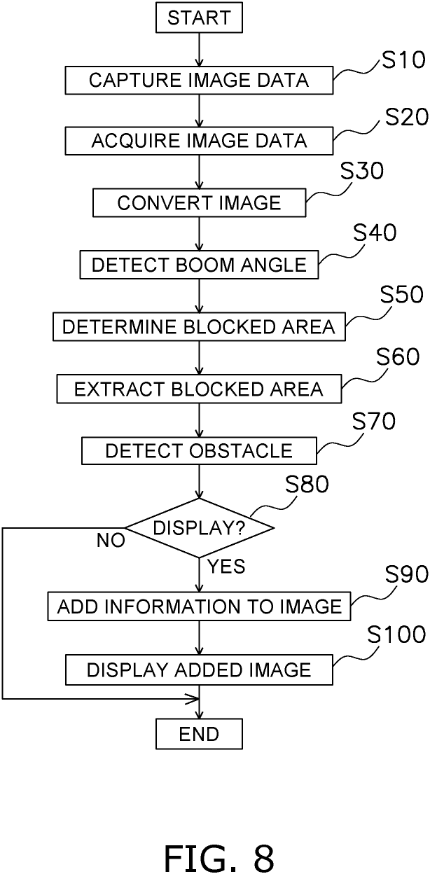

FIG. 8 is a flow chart showing the operation of the hydraulic excavator 1 of the present embodiment.

First, in step S10, the imaging section 41 of the detection section 4 captures the image data P1 in the region R1. Step S10 corresponds to an example of an imaging step.

Next, in step S20, the image data acquisition section 71 acquires the image data P1 (see FIG. 7A) from the imaging section 41 of the detection section 4 that detects an object in the region R1, and acquires the object information from the object detection section 42.

Next, in step S30, the image conversion section 72 converts the angle of view of the acquired image data P1 so as to match the viewpoint from the operator seated in the driver’s seat 231 to create the image data P2 (see FIG. 7B).

Next, in step S40, the boom angle detection section 31b detects the elevation angle of the boom 31 (boom angle). Step S40 corresponds to an example of the boom angle detection step.

Next, in step S50, the blocked area determination section 73 determines the area S1 (see FIG. 7C) blocked by the boom 31 based on the boom angle detected by the boom angle detection section 31b. Step S50 corresponds to an example of a blocked area determination step.

Next, in step S60, the blocked area extraction section 74 extracts the image data P3 (see FIG. 7D) of the blocked area S1 determined in step S50 from the image data P2 whose angle of view is changed in step S30.

Next, in step S70, the obstacle detection section 75 detects an obstacle in the image data P3 of the extracted blocked area. In the example shown in FIG. 7D, based on the object information of the object detection section 42, the rock 101 in the image data P3 is detected as an obstacle since the rock 101 exists within a predetermined range from the vehicle body 2.

Next, in step S80, the display determination section 70 determines whether or not to display an image and/or a warning based on the detection of the operation. The display determination section 70 determines to perform a warning display about an obstacle in the right front direction, for example, in the case of forward travel or working state.

In step S80, for example, when the vehicle body 2 is stopped and the work implement 3 is not operated, the display determination section 70 determines not to display the image and/or the warning, and the control ends.

When it is determined in step S80 that the display determination section 70 displays the image and/or the warning, the control proceeds to step S90.

In step S90, the image addition section 76 adds the information of the detected obstacle to the image data P3 extracted in step S60 to create image data P4 (see FIG. 7E). The information of the detected obstacle is a circle 103 surrounding the rock 101 which is an obstacle in FIG. 7E.

Next, in step S100, as shown in FIG. 4, the display control section 77 controls the projection section 5 so as to project the image data P4 created in step S70 onto the left side surface 31a of the boom 31 and the control ends. Step S100 corresponds to an example of a display step.

The hydraulic excavator 1 (an example of a work machine) of the present embodiment includes the vehicle body 2, the work implement 3, the display section 6, the detection section 4, and the display control section 77. The vehicle body 2 includes a driver’s seat 231. The work implement 3 is attached to the vehicle body 2 and operates with respect to the vehicle body 2. The display section 6 is provided on the work implement 3 as shown in FIGS. 3 and 5. As shown in FIG. 4, the detection section 4 detects an object in the region R1 on the side opposite to the driver’s seat 231 with respect to the work implement 3 around the vehicle body 2. The display control section 77 displays the information detected by the detection section 4 on the display section 6.

By providing the display section 6 on the work implement 3 in this way, since the window 23a is not used as a display section, the operator’s visibility through the window is not impaired. Further, by displaying the information about the object existing in an area of the blind spot blocked by the work implement 3 on the display section 6 of the work implement 3, the operator sees the display section 6 provided on the work implement 3 and checks the object existing in the blind spot.

In the above-described embodiment, the object existing in the blind spot corresponds to a part of the dump truck 100 and the rock 101.

Further, by detecting the object in the region R1 on the side opposite to the driver’s seat 231 with respect to the work implement 3, information about the object existing in the blind spot of the operator can be displayed on the display section 6, and the operator can check the object existing in the blind spot.

In the hydraulic excavator 1 of the present embodiment, the detection section 4 includes the imaging section 41 to capture an image. The display control section 77 displays the image data P4 based on the captured image data P1 on the display section 6.

As a result, when the field of view from the driver’s seat 231 is blocked by work implement 3, information regarding an object existing in the blocked area can be displayed on the display section.

The hydraulic excavator 1 of the present embodiment further includes the projection section 5 disposed on the vehicle body 2. The display section 6 is a part of the left side surface 31a of the work implement 3. The display control section 77 projects data on the display section 6 by the projection section 5.

This makes it possible to project and display information about objects existing in the operator’s blind spot on work implement.

The hydraulic excavator 1 of the present embodiment further includes the obstacle detection section 75 that detects an obstacle based on the detection of the detection section 4. When the view to the obstacle from the driver’s seat 231 is blocked by the work implement 3, the display control section 77 causes the display section 6 to display a warning based on the detection result of the obstacle.

As a result, it is possible to determine whether or not an obstacle exists based on the detection result of the detection section 4, and when an obstacle exists, it is possible to notify the operator to that.

In the hydraulic excavator 1 of the present embodiment, the work implement 3 includes the boom 31 installed on the right side of the driver’s seat 231 in the width direction of the vehicle body 2. The boom 31 can operate in front of the vehicle body 2. The detection section 4 detects an object in the area on the right side in front of the vehicle body 2.

Thereby, in the hydraulic excavator 1, it is possible to display information about an object existing in a blind spot where the view from the driver’s seat 231 is blocked by the boom 31.

In the hydraulic excavator 1 of the present embodiment, the detection section 4 includes the imaging section 41 to capture the image. The hydraulic excavator 1 includes the boom angle detection section 31b, the blocked area determination section 73 and the blocked area extraction section 74. The boom angle detection section 31b detects the angle of the boom 31. The blocked area determination section 73 determines the blocked area S1 in which the operator’s field of view is blocked by the boom 31 based on the detected angle of the boom 31. The blocked area extraction section 74 extracts the image data P3, which corresponds to the blocked region S1, from the image data P1 captured by the imaging section 41. The display control section 77 displays the image based on the extracted image data P3 on the display section 6 provided on the boom 31.

As a result, only the image of the area where the field of view is blocked by the boom 31 can be displayed on the left side surface 31a of the boom 31. For example, when the projection is performed on the left side surface 31a using the projection section 5, since the projection can be performed only on the boom 31, the light is not radiated to the part other than the boom 31, and the reflection or the like can be prevented as much as possible.

In the hydraulic excavator 1 of the present embodiment, the vehicle body 2 includes the revolving unit 22 and the traveling unit 21. The cab 23 (an example of the driver’s seat) and work implement 3 are disposed on the revolving unit 22.

In this way, in the hydraulic excavator 1 in which the cab 23 and the work implement 3 are provided on the revolving unit 22, the operator can recognize the object existing in the blind spot without impairing the visibility from the cab 23.

The control method for the hydraulic excavator 1 of the present embodiment includes step S10 (an example of an imaging step), step S40 (an example of a boom angle detection step), step S50 (an example of a blocked area determination step), and step S60 (an example of a blocked region extraction step) and a step S100 (an example of a display step). Step S10 images the image data P1 in the region R1 on the side opposite to the cab 23 (an example of the driver’s seat) with respect to work implement 3 around the vehicle body 2. Step S40 detects the elevation angle of the boom 31. Step S50 determines the blocked area S1 in which the operator’s field of view is blocked by the boom 31 based on the detected elevation angle of the boom 31. Step S60 (an example of a blocked region extraction step) extracts the image data P3, which corresponds to the blocked region S1, from the image data P2 captured by the imaging section 41. Step S100 displays the image data P4 based on the extracted image data P3 on the side surface of the boom 31 performed elevation.

By providing the display section 6 on the work implement 3 in this way, since the window 23a is not used as the display section, the operator’s visibility through the window is not impaired. Further, by displaying the information about the object existing in an area of the blind spot blocked by the work implement 3 on the display section 6 of the work implement 3, the operator sees the display section 6 provided on the work implement 3 and can check that the object exists in the blind spot.

### Embodiment 2

Hereinafter, the hydraulic excavator 201 (an example of a work machine) of the second embodiment according to the invention will be described.

Unlike the first embodiment, the hydraulic excavator 201 of the second embodiment is not provided with the projection section 5, the display section includes a self-luminous device, and notifies the operator of the existence of an object in the region R1 by lighting the self-luminous device. In the second embodiment, a configuration different from that of the first embodiment will be mainly described, and the same configurations as those of the first embodiment are designated by the same reference numerals and the description thereof will be omitted.

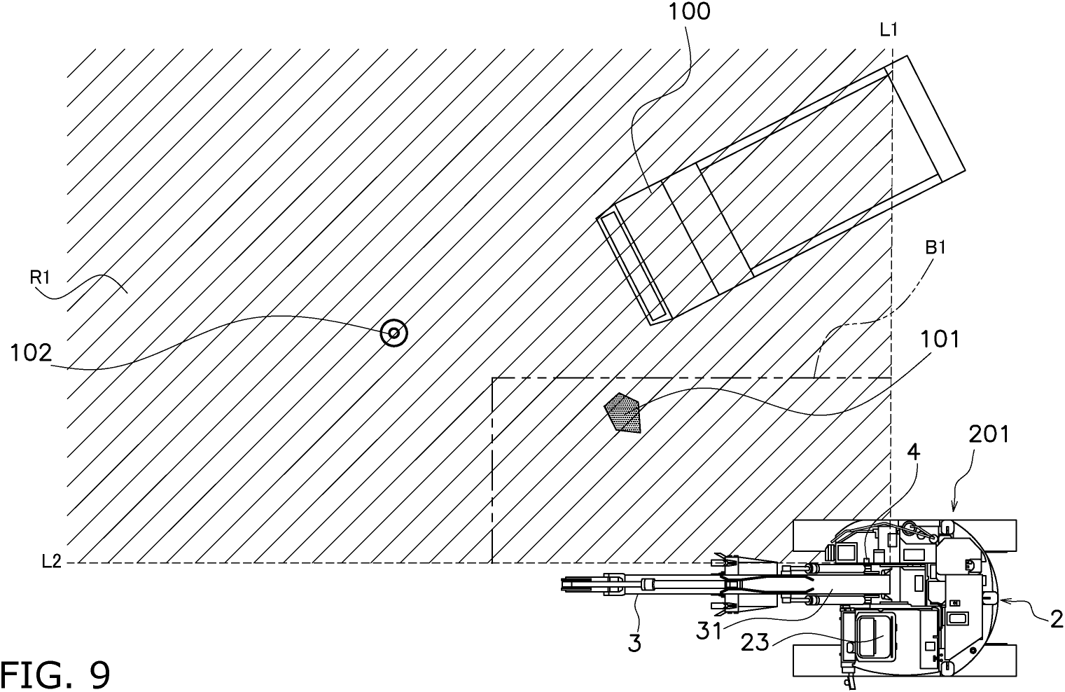

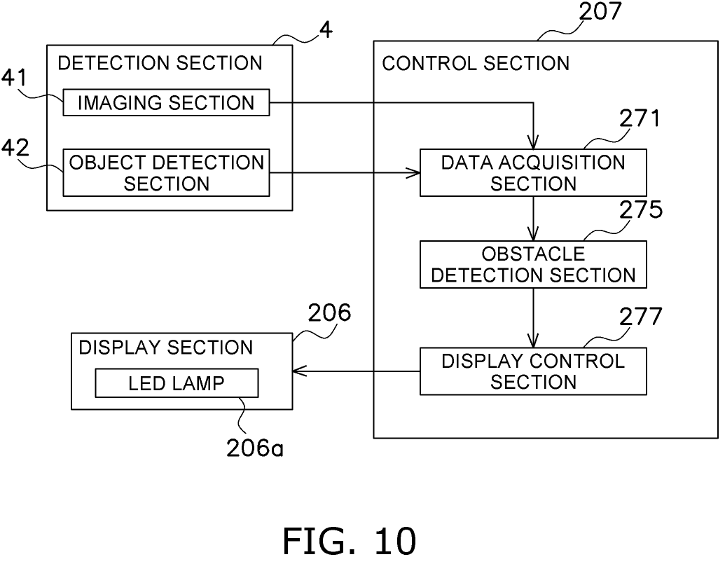

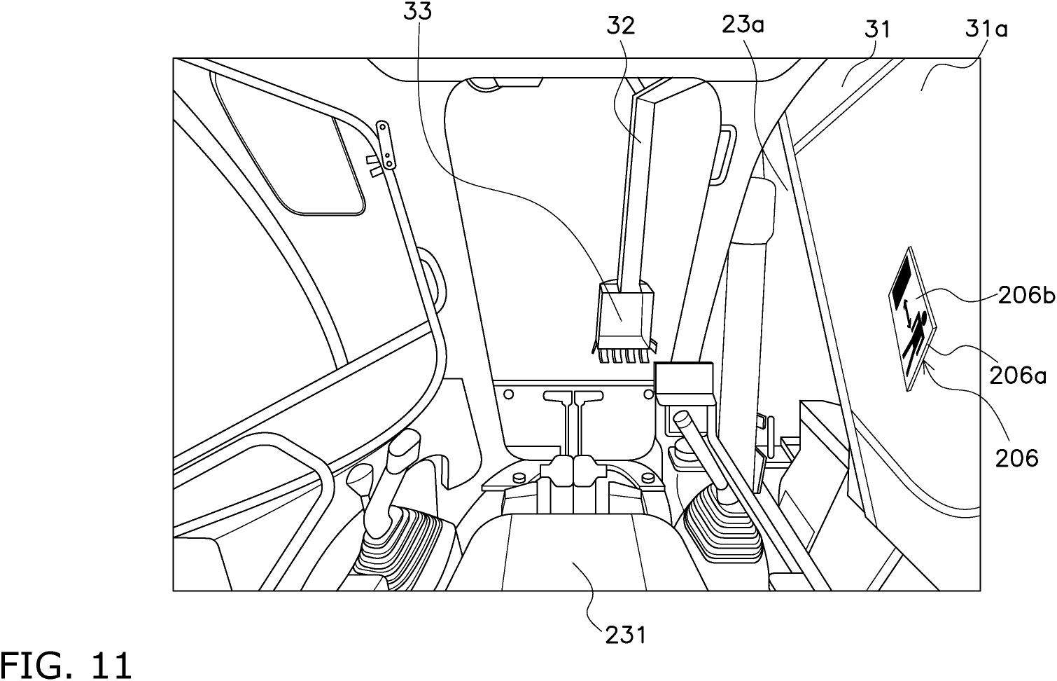

FIG. 9 is a plan view of the hydraulic excavator 201 of the second embodiment. FIG. 10 is a block diagram showing a control configuration of the hydraulic excavator 201 of the second embodiment. FIG. 11 is a view showing a field of view from an operator seated in the driver’s seat 231 in the hydraulic excavator 201 of the second embodiment.

The hydraulic excavator 201 of the second embodiment includes the vehicle body 2, the work implement 3, the detection section 4, a display section 206, and a control section 207.

The display section 206 notifies the operator of the existence of an object in the region R1. The display section 206 is disposed on the left side surface 31a of the boom 31 as shown in FIG. 11.

The display section 206 includes one or more LED lamps 206a (see FIG. 10) and a panel 206b (see FIG. 11) on which a pattern or characters are drawn. A plurality of LED lamps 206a including different colors may be provided, or one or more monochromatic LED lamps 206a may be provided. Further, it is not limited to the LED lamp, and another self-luminous device (for example, an incandescent lamp or the like) may be provided. The panel 206b is attached to the surface of the LED lamp 206a. As shown in FIG. 11, the panel 206b represents the approach of a person to the hydraulic excavator in the present embodiment, but is not limited to this. Further, the panel 206b may not be provided, and only the LED lamp 206a may be provided. Further, the panel may be a resin plate or a seal-like decal.

Further, the panel 206b may not be disposed on the surface of the LED lamp 206a, the panel 206b is directly disposed on the left side surface 31a of the boom 31, and the LED lamp 206a may be disposed on the boom 31 so as to be able to illuminate the panel 206b.

The LED lamp 206a can be supplied electricity by disposing a harness on the surface of the boom 31.

The control section 207 shown in FIG. 10 includes a processor and a storage device. The processor is, for example, a CPU (Central Processing Unit). Alternatively, the processor may be a processor different from the CPU. The processor executes a process for controlling the hydraulic excavator 201 according to a program. The storage device includes a non-volatile memory, such as ROM (Read Only Memory) and a volatile memory, such as RAM (Random Access Memory). The storage device may include an auxiliary storage device, such as a hard disk or an SSD (Solid State Drive). A storage device is an example of a non-transitory recording medium that can be read by a computer. The storage device stores programs and data for controlling the hydraulic excavator 201.

The control section 207 includes the following functions by executing a program while using the data stored in the storage device.

The control section 207 includes a data acquisition section 271, an obstacle detection section 275, and a display control section 277.

The data acquisition section 271 acquires the image data P1 (see FIG. 7A) of the region R1 from the imaging section 41, and acquires the data related to the object information (for example, the distance from the vehicle body 2) in the region R1 from the object detection section 42.

The obstacle detection section 275 detects an obstacle based on the data from the detection section 4. The obstacle detection section 275 detects an obstacle from the image data P1 of the region R1. The obstacle detection section 275 stores, for example, the shape and/or color, etc of an object that may become an obstacle, such as a truck, a road cone, a stone and the like. The obstacle detection section 275 extracts an outline of the object from the image data, collates the extracted outline and/or the color inside the outline with the object stored in advance as a database. And when the outline-extracted object matches the object stored in the database, the obstacle detection section 275 detects the outline-extracted object (dump track 100, load cone 102 and rock 101 in FIG. 11) as an obstacle.

The obstacle detection section 275 detects whether or not the object detected as an obstacle exists within a predetermined range B1 (two-dot chain line) from the vehicle body 2. In FIG. 9, the predetermined range B1 is set in a rectangular shape in which the length of the range is changed between the front side and the side surface side of the hydraulic excavator 201, but it is not limited to this, and the predetermined range B1 may be set to a fan shape within a certain range from the outer shape of the hydraulic excavator 201, and it is not particularly limited.

When the obstacle detection section 275 detects an obstacle, the display control section 277 controls the display by the display section 206 based on the distance of the obstacle from the vehicle body 2. When an obstacle is detected in the predetermined range B1, the display control section 277 lights the display section 206, for example, in red. When an obstacle is detected outside the predetermined range B1, the display control section 277 lights the display section 206, for example, in yellow. In the example shown in FIG. 9, since the rock 101 exists inside the predetermined range B1, the display control section 277 lights the display section 206 in red.

As a result, it is possible to notify the operator that the obstacle is located near the hydraulic excavator 201, and it is possible to call more attention.

It is not necessary to change the lighting color of the display section 206 with reference to the predetermined range B1, and the lighting state may be changed. For example, when an obstacle is detected outside the predetermined range B1, the display section 206 is constantly lit, and when an obstacle is detected inside the predetermined range B1, the display section 206 is blinked.

### Operation

Next, the operation of the hydraulic excavator 201 of the present embodiment according to the disclosure will be described, and an example of the control method for the work machine will be described at the same time.

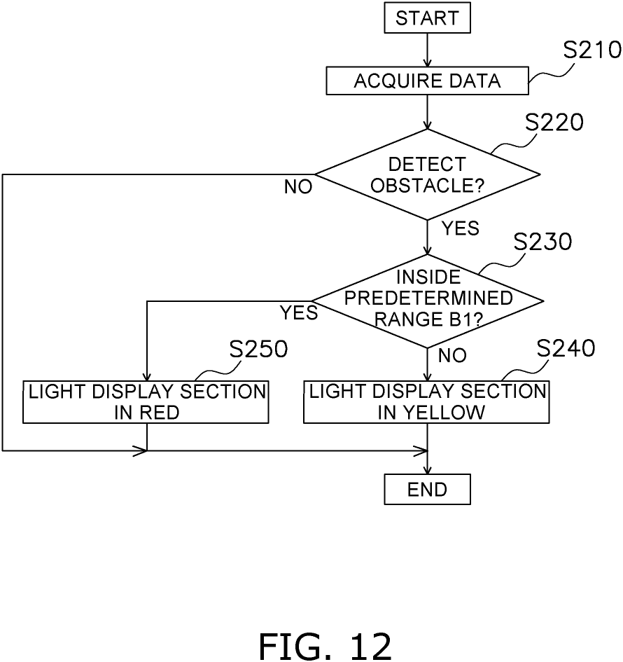

FIG. 12 is a flow chart showing the operation of the hydraulic excavator 201 of the present embodiment.

First, in step S210, the data acquisition section 271 acquires image data P1 (see FIG. 7A) from the imaging section 41 of the detection section 4 that detects an object in the region R1, and acquires data related to the object information from the object detection section 42.

Next, in step S220, the obstacle detection section 275 detects an obstacle based on the image data P1 and the object information. When an obstacle is detected by the obstacle detection section 275 in step S220, the control proceeds to step S230. Further, the obstacle detection section 275 calculates the distance of the detected obstacle from the hydraulic excavator 201 based on the data related to the object information.

On the other hand, when the obstacle detection section 275 does not detect an obstacle in step S220, the control ends.

When an obstacle is detected, in step S230, the obstacle detection section 275 determines whether or not the detected obstacle exists within the predetermined range B1 based on the calculated distance from the hydraulic excavator 201.

When it is determined that the obstacle does not exist within the predetermined range B1 in step S230, the display control section 277 lights the display section 206 in yellow and the control ends.

On the other hand, when it is determined that the obstacle exists within the predetermined range B1 in step S230, the display control section 277 lights the display section 206 in red and the control ends.

The steps S210 to S250 are repeated at predetermined intervals, and after an obstacle is detected and the display section 206 lights up in yellow, when the obstacle is detected within the predetermined range B1 from the data acquired by the detection section 4, the display section 206 may be lit in red. Further, after the obstacle is detected and the display section 206 is turned on, when the obstacle is not detected from the data acquired by the detection section 4, the display section 206 may be turned off.

The hydraulic excavator 201 (an example of a work machine) of the present embodiment includes the vehicle body 2, the work implement 3, the display section 206, the detection section 4, and the display control section 277. The vehicle body 2 includes the driver’s seat 231. The work implement 3 is attached to the vehicle body 2 and operates with respect to the vehicle body 2. The display section 206 is provided in the work implement 3 as shown in FIG. 1. As shown in FIG. 9, the detection section 4 detects an obstacle (an example of an object) in the region R1 on the side opposite to the driver’s seat 231 of the work implement 3 around the vehicle body 2. The display control section 277 displays the information corresponding to the detection of the detection section 4 on the display section 206.

By providing the display section 206 in the work implement 3 in this way, since the window 23a is not used as the display section, the operator’s visibility through the window is not impaired. Further, by displaying the information on the obstacle existing in an area of the blind spot blocked by the work implement 3 on the display section 206 of the work implement 3, the operator sees the display section 206 provided on the work implement and can recognize an obstacle existing in the blind spot.

Further, by detecting an obstacle in the region R1 on the side opposite to the driver’s seat 231 with respect to the work implement 3, information about the obstacle existing in the blind spot of the operator can be displayed on the display section 206, and the operator can recognize the obstacle in the blind spot.

In the hydraulic excavator 201 of this embodiment, the work implement 3 includes the boom 31, the arm 32, and the excavation bucket 33. The display section 206 is installed on the boom 31.

As a result, information can be displayed on the boom 31 in response to the detection of an obstacle existing in the area of the blind spot where the field of view from the driver’s seat 231 is blocked.

In the hydraulic excavator 201 of the present embodiment, the work implement 3 includes the boom 31 installed on the right side of the driver’s seat 231 in the width direction of the vehicle body 2. The boom 31 can operate in front of the vehicle body 2. The detection section 4 detects an obstacle in the area on the right side in front of the vehicle body 2.

Thereby, in the hydraulic excavator 201, it is possible to display information about an obstacle existing in an area of the blind spot where the view from the driver’s seat 231 is blocked by the boom 31.

In the hydraulic excavator 201 of the present embodiment, the display section 206 includes the LED lamp 206a (an example of a self-luminous device).

Thereby, by controlling the LED lamp 206a, it is possible to notify the operator that an obstacle exists.

In the hydraulic excavator 201 of the present embodiment, when an obstacle (an example of an object) is detected in the region R1 by the detection section 4, the display control section 277 lights the LED lamp 206a.

Thereby, by lighting the LED lamp 206a, it is possible to notify the operator that an obstacle exists in the blind spot.

In the hydraulic excavator 201 of the present embodiment, when an obstacle (an example of an object) is detected in the region R1 by the detection section 4, the display control section 277 changes the display of the display section 206 according to the distance to the obstacle.

This makes it possible to notify the operator of the distance to the obstacle.

In the hydraulic excavator 201 of the present embodiment, the display section 206 includes the LED lamp 206a. The display control section 277 changes the lighting of the LED lamp 206a between when an obstacle is detected outside the predetermined range B1 from the hydraulic excavator 201 and when an obstacle is detected inside the predetermined range B1.

This makes it possible to notify the operator whether or not the obstacle is located in the vicinity of the hydraulic excavator 201.

In the hydraulic excavator 201 of the present embodiment, the display control section 277 changes the lighting color or interval of the LED lamp 6a between the outside and the inside of the predetermined range B1.

This makes it possible to notify the operator whether or not the obstacle is located in the vicinity of the hydraulic excavator 201.

In the hydraulic excavator 1 of the present embodiment, the vehicle body 2 includes the revolving unit 22 and a traveling unit 21. The cab 23 (an example of the driver’s seat) and the work implement 3 are installed on the revolving unit 22.

In this way, in the hydraulic excavator 1 in which the cab 23 and the work implement 3 are provided on the revolving unit 22, the operator can recognize the object existing in the blind spot without impairing the visibility from the cab 23.

The control method of the hydraulic excavator 201 of the present embodiment includes steps S210 (an example of an acquisition step) and steps S240 and S250 (an example of a display step). Step S210 acquires information about an object in the area on the side opposite to the driver’s seat 231 with respect to the work implement 3 around the vehicle body 2. Steps S240 and S250 display the acquired information on the display section 206 provided in the work implement 3.

By providing the display section 206 in the work implement 3 in this way, since the window 23a is not used as the display section, the operator’s visibility through the window is not impaired. Further, by displaying the information about an object existing in an area of the blind spot blocked by the work implement 3 on the display section 206 of the work implement 3, the operator sees the display section 206 provided on the work implement and recognizes an object existing in the blind spot.

### Other Embodiments

Embodiments of the present invention were described above, but the present invention is not limited to or by the above embodiments, and various modifications are possible without departing from the gist of the invention

In the first embodiment, the image is displayed only on the boom 31, but as shown in FIG. 5, the view of the operator seated in the driver’s seat 231 is also blocked by the arm 32 and the excavation bucket 33. Therefore, the image may be projected not only on the boom 31, but also on the arm 32 and the excavation bucket 33. In this case, the angle of the arm 32 and the angle of the excavation bucket 33 are also input to the blocked area determination section 73, the blocked area including the boom 31, arm 32 and the excavation bucket 33 is determined, and an image of the blocked area is projected to the boom 31, the arm 32 and the excavation bucket 33.

In the first embodiment, since only the image of the area where the field of view is blocked by the boom 31 is extracted by the blocked area extraction section 74, only the extracted image data P3 is projected, but the present invention is limited to this. For example, the projection section 5 may project all the image data P2 whose angle of view is only converted from the image data P1 captured by the imaging section 41. In this case, an image is projected on the part other than the boom 31, but the image does not appear because there is no object to be projected.

In the first embodiment, the image conversion section 72 changes the angle of view of the image data projected on the boom 31, but the angle of view may not be changed if only the rough position of the object is recognized. Further, when the difference in the field of view between the position of the detection section 4 and the position of the operator seated in the driver’s seat 231 is small, it is not necessary to change the angle of view.

In the first embodiment, the imaging section 41 is provided and the image captured by the imaging section 41 is displayed on the display section 6, but the imaging section 41 may not be provided. In this case, the display section 6 may not display the image and may display only the position of the obstacle.

In the first embodiment, the object detection section 42 is provided to detect the distance to the object, but the object detection section 42 may not be provided. In this case, an obstacle may be detected by calculating the distance to the object based on the image taken by the imaging section 41, and a warning display may be performed.

In the first embodiment, the image is displayed on the left side surface 31a of the boom 31 by the projection section 5 projecting, but the projection section 5 may not be provided. For example, a self-luminous device, such as an LED panel, may be attached to the left side surface 31a as an example of the display section. The display control section 77 controls to display the image data P4 on the LED panel. The self-luminous device may include a lamp or the like.

In the first embodiment, the image data P4 is created by adding a warning display to the image data P3, and the image data P4 is displayed on the display section 6, but only the image data P3 may be displayed without displaying the warning.

In the first embodiment, the image data P4 is created by adding a warning display to the image data P3, and the image data P4 is displayed on the display section 6, but the image data P3 is not displayed and only a warning display regarding an obstacle may be performed. In this case, since it is easy for the operator to recognize the obstacle, it is preferable to display a warning at the position of the display section 6 corresponding to the position of the obstacle. Further, when an LED panel or the like is used instead of the projection section 5, the LED at the position of the display section corresponding to the position of the obstacle may be turned on.

The operation flow of the first embodiment can be appropriately changed as long as it does not affect the invention. For example, in the above embodiment, the obstacle is detected after the image data P3 of the blocked area S1 is extracted, but the obstacle may be detected for the image data P1 acquired in step S20. In this case, an obstacle not included in the image data P3 is excluded in the extraction of the blocked area.

Further, for example, in the above embodiment, the shield region S1 is extracted after creating the image data P2 by changing the angle of view of the acquired image data P1, but the present invention is not limited to this.

Since the blocked area of the image data P1 can be associated with the angle of the boom 31 in advance, the angle of view may be changed after the image data obtained by extracting the blocked area from the image data P1 is created.

In the first and second embodiments described above, the driver’s seat 231 is provided in the cab 23, and a window is provided on the side surface of the driver’s seat 231 but the canopy type driver’s seat which is not provided with the window may be provided.

Although the hydraulic excavator has been described as an example of the work machine in the first and second embodiments, the present invention is not limited to this, and for example, a wheel loader, a bulldozer, or the like may be used. In short, the present invention can be applied to any work machine other than a hydraulic excavator as long as the operator’s field of view is blocked by the work implement and an image of the blocked area can be displayed in the blocking part.

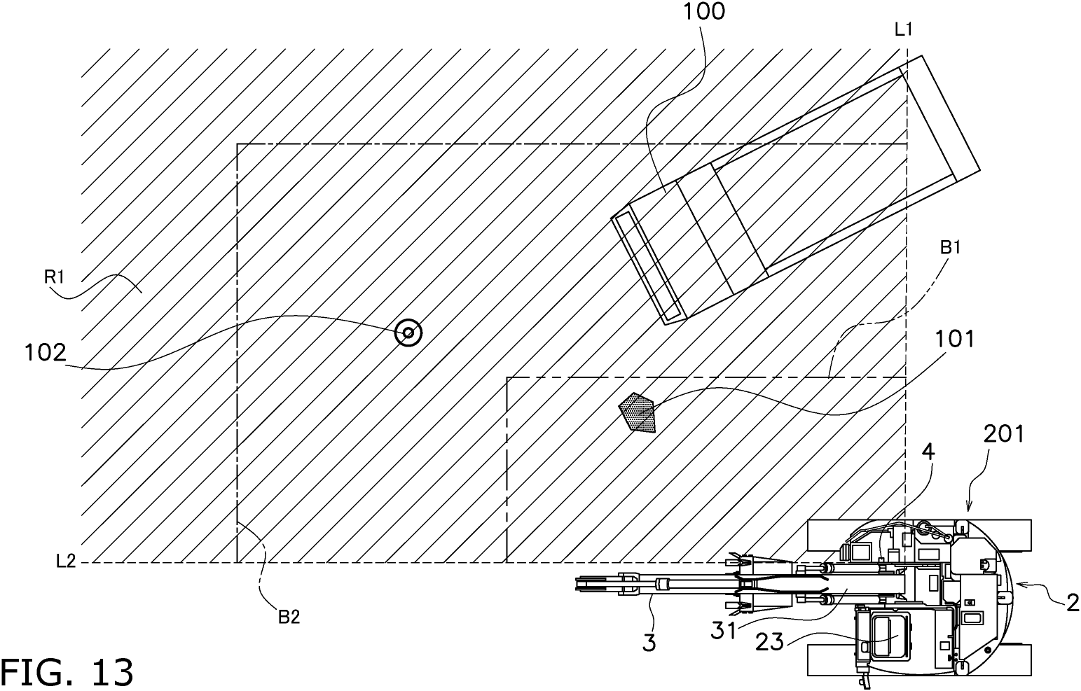

In the second embodiment, all the objects detected from the image data P1 are detected as obstacles, but the distance of the object to the vehicle body 2 in the image data P1 is detected based on the data of the object detection section 42, and when the distance is within the predetermined range B2, the object may be detected as an obstacle. FIG. 13 is a plan view showing a predetermined range B2 from the vehicle body 2. In FIG. 13, the boundary indicating a predetermined range is shown as B2 (one dot chain line). The predetermined range B2 is set outside the predetermined range B1 of the above embodiment. Further, the predetermined range B2 is set in a rectangular shape in which the length of the range is changed between the front side and the side surface side of the hydraulic excavator 201 in FIG. 13, but the shape is not limited to this, and the predetermined range B2 may be set to a fan shape within a certain range from the outer shape of the hydraulic excavator 201, and it is not particularly limited.

In this case, when an obstacle is detected inside the predetermined range B2 and outside the predetermined range B1, the display control section 277 turns on the LED lamp 206a, for example, in yellow, and when the obstacle is detected inside the predetermined range B1, the display control section 277 may turn on the LED lamp 206a, for example, in red.

Further, not only the object in the predetermined range B1 from the hydraulic excavator 201 is detected as an obstacle, but also, for example, the object may be determined as an obstacle by the object approaching the hydraulic excavator 201 even when the object is located at a position farther than the predetermined range B2.

As shown in FIG. 13, in the case that the predetermined range B1 and the predetermined range B2 are provided, when an obstacle is detected inside the predetermined range B1, the LED lamp 206a may be turned on in red and when an obstacle is detected outside the predetermined range B1 and inside the predetermined range B2, the LED lamp 206a may be turned on in yellow and when an obstacle is detected outside the predetermined range B2, the LED lamp 206a may be turned on in green. As a result, the operator can recognize the distance to the obstacle and visually recognize the safety.

In the second embodiment, the display of the display section 206 is changed depending on whether the obstacle is detected inside or outside the predetermined range B1, but the predetermined range B1 may not be provided and it is not necessary to change the display of display section 206. For example, when an obstacle is detected in the region R1, the display section 206 may be simply turned on. In this case, it is not necessary to detect the distance from the hydraulic excavator to the obstacle.

In the second embodiment, the obstacle in the region R1 in front of the right side surface is detected, but the obstacle existing in the region behind the right side surface may not be detected. In that case, when an obstacle exists in the region R1 or the area behind the right side surface, the LED lamp 206a of the display section 206 may be turned on, or the LED lamp for the area behind the right side surface may be provided in addition to the LED lamp 206a.

Also in the hydraulic excavator 201 of the second embodiment, the display determination section 70 described in the first embodiment may be provided in the control section 207 and, when an obstacle is detected, it may be determined whether or not the display section 206 is lit based on the detection of the operation. That is, for example, when the vehicle is traveling forward or backward or in a working state, the LED lamp 206a is turned on.

In the second embodiment, the imaging section 41 is provided, but the imaging section 41 may not be provided. In this case, the object detection section 42 may detect an obstacle.

In the second embodiment, the object detection section 42 is provided to detect the distance to the object, but the object detection section 42 may not be provided. In this case, an obstacle may be detected by calculating the distance to the object based on the image taken by the imaging section 41, and a warning display may be performed.

In the above embodiment, the excavation bucket 33 is attached to the tip end of the arm 32 as an example of an attachment, but the attachment is not limited to the excavation bucket 33, and other attachments such as a breaker and a grapple may be attached.

The work machine and the control method for the work machine of the present invention have the effect that the operator can recognize the object existing in the blind spot without impairing the visibility from the driver’s seat and are useful in a hydraulic excavator, a wheel loader or the like.

1. A work machine comprising:
a vehicle body including a driver’s seat;
a work implement attached to the vehicle body, the work implement being configured to operate with respect to the vehicle body;
a display section disposed on the work implement;
a detection section configured to detect an object in a region on a side opposite to the driver’s seat with respect to the work implement around the vehicle body; and
a display control section configured to display information detected by the detection section on the display section.

2. The work machine according to claim 1, wherein
the detection section includes an imaging section configured to capture an image, and
the display control section is configured to display an image based on the captured image on the display section.

3. The work machine according to claim 1, further comprising
a projection section disposed on the vehicle body,
the display section being a part of a surface of the work implement, and
the display control section projecting the information on the display section by the projection section.

4. The work machine according to claim 1, further comprising
an obstacle detection section configured to detect an obstacle based on detection of the detection section,
when a view from the driver’s seat is blocked by the work implement, the display control section causing the display section to display a warning based on a detection result of an obstacle.

5. The work machine according to claim 1, wherein
the work implement includes a boom installed on a first direction side of the driver’s seat in a width direction of the vehicle body,
the boom is configured to operate in front of the vehicle body,
the detection section is configured to detect an object in a region on the first direction side in front of the vehicle body, and
the work machine is a hydraulic excavator.

6. The work machine according to claim 5, further comprising a boom angle detection section configured to detect the boom angle,
a blocked area determination section configured to determine a blocked area in which an operator’s field of view is blocked by the boom based on a detected angle of the boom, and
a blocked area extraction section,
the detection section including an imaging section configured to capture an image,
the blocked area extraction section being configured to extract image data of the blocked area from an image data captured by the imaging section, and
the display control section being configured to display an image based on a extracted image data on the display section provided on the boom.

7. A work machine comprising:
a vehicle body including a driver’s seat;
a work implement attached to the vehicle body, the work implement being configured to operate with respect to the vehicle body;
a display section disposed on the work implement;
a detection section configured to detect an object in a region on a side opposite to the driver’s seat with respect to the work implement around the vehicle body; and
a display control section configured to display information according to a detection result of the detection section on the display section.

8. The work machine according to claim 7, wherein
the work implement includes a boom, an arm, and an attachment, and
the display section is installed on the boom.

9. The work machine according to claim 7,wherein
when an object is detected in the area by the detection section, the display control section causes the display section to display a warning.

10. The work machine according to claim 7, wherein
the display section includes a self-luminous device.

11. The work machine according to claim 9, wherein
the display section includes an LED panel.

12. The work machine according to claim 10, wherein
when an object is detected in the area by the detection section, the display control section turns on the self-luminous device.

13. The work machine according to claim 10, wherein
the self-luminous device is a lamp.

14. The work machine according to claim 1, wherein
when an object is detected in the area by the detection section, the display control section changes a display of the display section according to a distance to the object.

15. The work machine according to claim 14, wherein
the display section includes a self-luminous device, and
the display control section changes a lighting of the self-luminous device between when the object is detected outside a predetermined range from the work machine and when the object is detected inside the predetermined range.

16. The work machine according to claim 15, wherein
the display control section changes a lighting color or interval of the self-luminous device between inside and outside the predetermined range.

17. The work machine according to claim 1, wherein
the vehicle body includes a revolving unit and a traveling unit,
the driver’s seat and the work implement are installed on the revolving unit, and
the work machine is a hydraulic excavator.

18. A control method for a work machine comprising:
an imaging step of capturing an image in a region on a side opposite to a driver’s seat with respect to a work implement around a vehicle body of a work machine;
a boom angle detection step of detecting an elevation angle of a boom included in the work implement;
a blocked area determination step of determining a blocked area in which an operator’s field of view is blocked by the boom based on the elevation angle of the boom;
a blocked area extraction step of extracting image data of the blocked area from a captured image data; and
a display step of displaying an image based on an extracted image data on a side surface of the boom performed elevation.

19. The work machine according to claim 7, wherein
when an object is detected in the area by the detection section, the display control section changes a display of the display section according to a distance to the object.

20. The work machine according to claim 7, wherein
the vehicle body includes a revolving unit and a traveling unit,
the driver’s seat and the work implement are installed on the revolving unit, and
the work machine is a hydraulic excavator.
